(19) United States
(12) Patent Application Publication
(10) Pub. No.: US 2011/0194762 A1
(43) Pub. Date: Aug. 11, 2011

(54) METHOD FOR DETECTING HAIR REGION

(75) Inventor: Ren HAIBING, Beijing (CN)

(73) Assignee: SAMSUNG ELECTRONICS CO., LTD., Suwon-si (KR)

(21) Appl. No.: 13/018,857

(22) Filed: Feb. 1, 2011

(30) Foreign Application Priority Data
Feb. 4, 2010 (CN) 201010112922.3
Jan. 4, 2011 (KR) 10-2011-0000503

(51) Int. Cl. G06K 9/00

(52) U.S. Cl. 382/165

(57) ABSTRACT

A method of detecting a hair region, includes acquiring a confidence image of a head region; and detecting the hair region by processing the acquired confidence image. The hair region detection method may detect the hair region by combining skin color, hair color, frequency, and depth information, and may segment the entire hair region in a noise background using a global optimization method instead of using a local information method.

### CROSS-REFERENCE TO RELATED APPLICATIONS

This application claims the priority benefit of Chinese Patent Application No. 201010112922.3, filed on Feb. 4, 2010, and Korean Patent Application No. 10-2011-0000503, filed on Jan. 4, 2011, the disclosures of which are incorporated herein by reference.

### BACKGROUND

1. Field

Example embodiments relate to a method of detecting a hair region that may accurately and quickly detect a hair region.

2. Description of the Related Art

Due to a variety of hairstyles, hair colors, and brightness, hair detection has been a significantly challenging research topic. Hair detection technology may be very useful for a virtual hairstyle design, a virtual human model, a virtual image design, and the like. Major companies have conducted research regarding a detection of a hair region for years. U.S. Patent Publication US20070252997 discusses equipment detecting a hair region using an image sensor and a light emitting apparatus. This equipment may solve an illumination issue using a specially designed light emitting apparatus, however may highly depend on a skin color and a clear background. Accordingly, a detection result may be unstable and application of the equipment may be limited. U.S. Patent Publication US2008215038 uses a 2-step method: initially confirming an approximate position of a hair region in a two-dimensional (2D) image and then detecting an accurate hair region in a three-dimensional (3D) image acquired through laser scanning. The 2-step method may be unsuitable due to an expensive laser scanner and an unfriendly user interface.

U.S. Pat. No. 6,711,286 discusses a method of detecting a skin color and yellow hair pixels present in skin pixels by combining red, green, blue (RGB) with a color space. This method may also be affected by unstable color information and a background region.

The aforementioned related art generally has two major issues: First, the existing detection methods are highly dependent on skin color and a clear background. Skin color changes at all times depending on a human being, an illumination, a camera, and an environment. Accordingly, detecting of a hair region using the aforementioned methods may be unstable and an inaccurate result may be obtained. Second, all of the above are based on a local information method, and whether a pixel belongs to a hair region may not be accurately verified using only the local information method.

### SUMMARY

Example embodiments provide a method of accurately and quickly detecting a hair region. The method may employ a color camera, for example, a charge coupled device (CCD) and a complementary metal-oxide semiconductor (CMOS), and a depth camera, and may align the color camera and the depth camera. In addition, the method may detect the hair region by combining skin color, hair color, frequency, and depth information, and may segment the entire hair region in a noise background using a global optimization method instead of using a local information method.

The foregoing and/or other aspects are achieved by providing a method of detecting a hair region, including: acquiring a confidence image of a head region; and detecting the hair region by processing the acquired confidence image. The acquiring of the confidence image may include acquiring a hair color confidence image through a color analysis with respect to a head region of a color image.

The acquiring of the confidence image may further include acquiring a hair frequency confidence image through a frequency analysis with respect to a gray scale image corresponding to the head region of the color image.

The acquiring of the confidence image may further include calculating a scenario region confidence image through a scenario analysis with respect to a depth image corresponding to the head region of the color image.

The acquiring of the confidence image may include acquiring a non-skin color confidence image through the color analysis with respect to the head region of the color image.

The detecting may include setting, to ‘1’, a pixel having a pixel value greater than a corresponding threshold value in each confidence image, based on a threshold value predetermined for each confidence image, and setting, to ‘0’, a pixel having a pixel value less than or equal to the corresponding threshold value, performing an AND operation with respect to a corresponding pixel of each confidence image, and determining, as the hair region, a region having a pixel value of ‘1’.

The processing may include calculating a pixel value of a corresponding pixel of a sum-image of each confidence image by multiplying a pixel value of each confidence image by a weight predetermined for each confidence image, and by adding up results of the multiplication, and determining whether the corresponding pixel of the sum-image belongs to the hair region based on a predetermined threshold value.

The processing may include determining whether a pixel belongs to the hair region, using a universal binary classifier based on each confidence image.

The processing may include calculating a pixel value of a corresponding pixel of a sum-image of each confidence image by multiplying a pixel value of each confidence image by a weight predetermined for each confidence image, and by adding up results of the multiplication, and determining whether the corresponding pixel of the sum-image belongs to the hair region based on a predetermined threshold value.

The processing may include determining whether a corresponding pixel belongs to the hair region using a global optimization method with respect to the acquired confidence image.

The global optimization method may correspond to a graph cut method, and the graph cut method may minimize an energy function E(ƒ) and segment an image into the hair region and a non-hair region, and the energy function may be given by,

E(ƒ)=E_{data}(ƒ)+Eₛₘₒₒₜₕ(ƒ),

where ƒ denotes all the pixel classes, each pixel class is classified as a non-hair pixel class and a hair pixel class, E_{data}(ƒ) denotes energy generated by an external force pulling a pixel to from a class of the pixel, and Eₛₘₒₒₜₕ(ƒ) denotes a smoothness energy value of a smoothness between neighboring pixels.

When m confidence images are present, each pixel value of an image may have m confidence values corresponding to the m confidence images. When a pixel is indicated by a hair class, data energy of the pixel may correspond to a weighted sum of m energies corresponding to m confidence values, and otherwise, the data energy of the pixel may correspond to a weighted sum of m-m energies where 2≦m≦4.

The hair region detecting method may further include obtaining a head region of the color image through segmentation of the color image.

A head region of a depth image corresponding to the color image may be determined based on a size and a position of the head region of the color image.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of embodiments, taken in conjunction with the accompanying drawings of which:

FIG. 1 illustrates a method of detecting a hair region according to example embodiments;

FIG. 2 illustrates an input red, green, blue (RGB) color image and a face and eye detection region according to example embodiments;

FIG. 3 illustrates a head region of a color image of FIG. 2;

FIG. 4 illustrates a head region of a depth image corresponding to the head region of the color image of FIG. 2;

FIG. 5 illustrates a confidence image of the head region of the depth image of FIG. 4;

FIG. 6 illustrates a hair color confidence image;

FIG. 7 illustrates a non-skin color confidence image;

FIG. 8 illustrates a design of a band pass filter;

FIG. 9 illustrates a hair frequency confidence image;

FIG. 10 illustrates a graph cut method;

FIG. 11 illustrates a detected hair region; and

FIG. 12 illustrates an apparatus to implement the method of FIG. 1

### DETAILED DESCRIPTION

Reference will now be made in detail to embodiments, examples of which are illustrated in the accompanying drawings, wherein like reference numerals refer to the like elements throughout. Embodiments are described below to explain the present disclosure by referring to the figures.

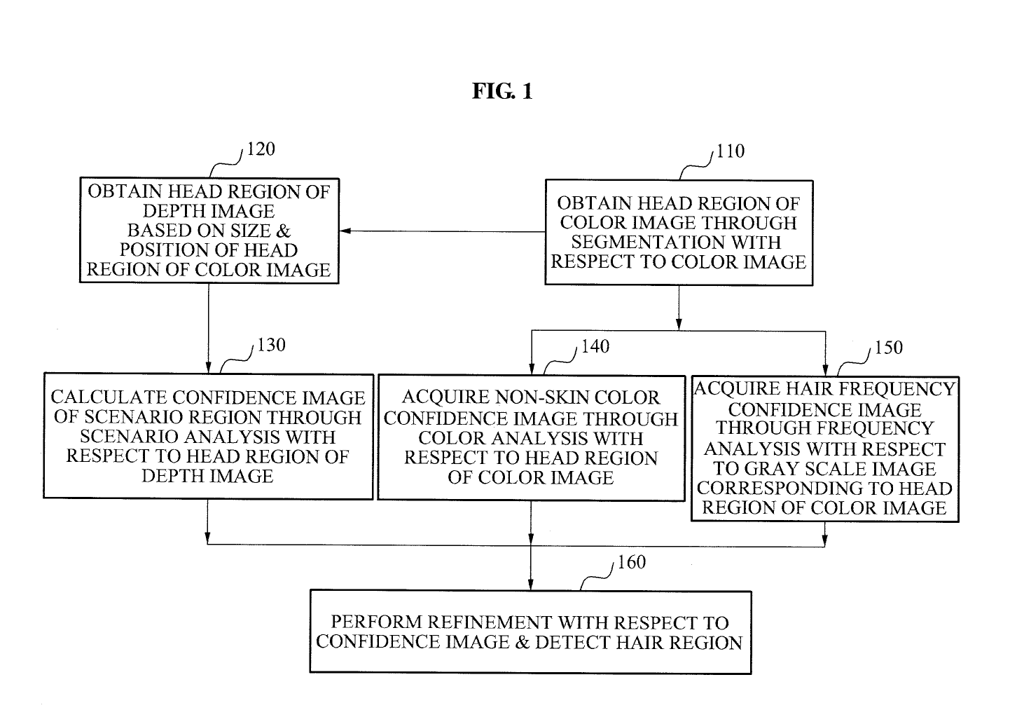

FIG. 1 illustrates a method of detecting a hair region according to example embodiments.

Referring now to FIG. 1, in operation 110, a head region of a color image may be obtained through segmentation with respect to a red, green, blue (RGB) color image. In operation 120, a head region of a depth image corresponding to the head region of the color image may be obtained based on a size and a position of the head region of the color image. In operation 130, a confidence image D of a scenario region may be calculated through a scenario analysis with respect to the head region of the depth image. In operation 140, a hair confidence image H may be acquired through a color analysis with respect to the head region of the color image. Operations 120 and 130 may be omitted depending on embodiments. In addition to obtaining of the hair confidence image H through the color analysis, a non-skin color confidence image N of the head region of the color image may also be acquired through the color analysis as necessary in operation 140. The method may include operation 150. In operation 150, a hair frequency confidence image F1 may be acquired through a frequency analysis with respect to a gray scale image corresponding to the head region of the color image. In operation 160, a refinement may be performed with respect to the acquired confidence image and the hair region may be detected. In FIG. 1, the acquired confidence image corresponds to an image acquired by combining the hair color confidence image and the hair frequency confidence image with at least one of the scenario region confidence image and the non-skin color confidence image.

Specifically, in operation 110, an accurate position of the head region may be verified using a face and eye detection method. A position and a size of the head region may be verified based on a position and a size of a face.

$$\{ \begin{matrix}x = x 0 - α0 * W 0 \\ y = y 0 - α1 * W 0 \\ W = α2 * W 0 \\ H = α3 * W 0\end{matrix}$$

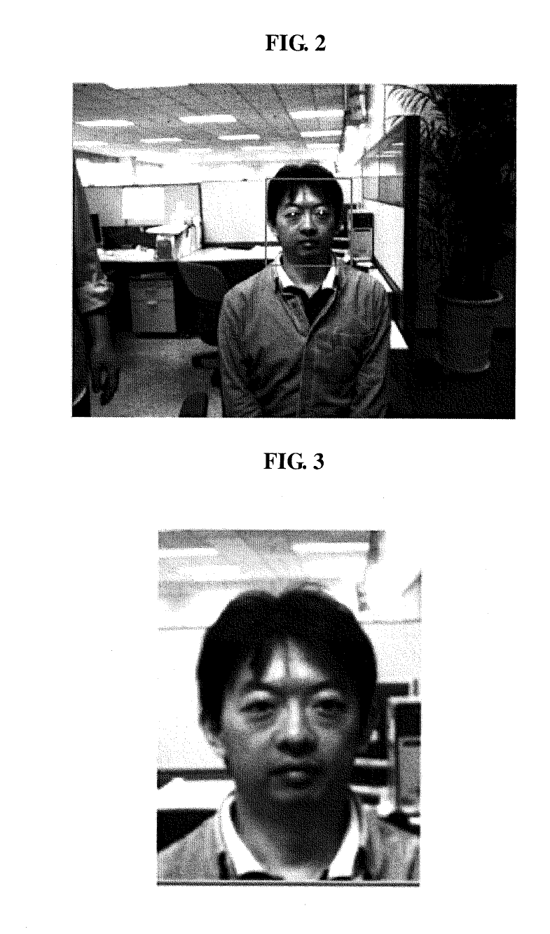

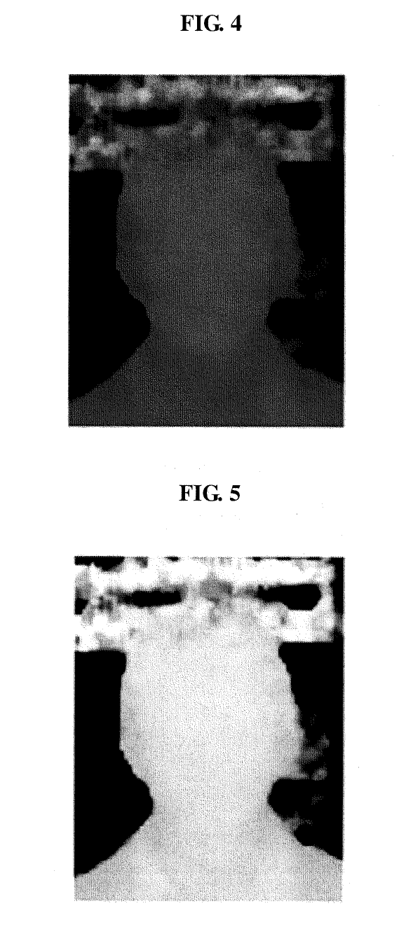

Here, coordinates (x, y) denotes an upper left corner of the head region, W denote a width of the head region, H denote a height of the head region, and (x0, y0) denotes a center position of a left eye, W0 denotes a distance between the left eye and a right eye, and α0 to α3 denote constants. The statistical mean of α0 to α3 may be obtained as a result of artificially marking center positions of the left eye and the right eye, and a face region in a plurality of face images. FIG. 2 illustrates an input RGB color image and a face and eye detection region. FIG. 3 illustrates the head region of the color image of FIG. 2. In operation 120, the head region of the depth image corresponding to the head region of the color image may be obtained based on the size and the position of the head region of the color image. FIG. 4 illustrates a head region of a corresponding depth image corresponding to the head region of the color image of FIG. 2.

In operation 130, the confidence image D of the scenario region of the head region of the depth image may be calculated by constructing a Gaussian model using an online training method. In the confidence image D of the scenario region, each of all the pixels may have a confidence value. The confidence value indicates a probability value that a corresponding pixel belongs to the scenario region.

Hereinafter, an example of a process of constructing the Gaussian model using the online training method will be briefly described. Initially, a statistical depth histogram of segmented depth images may be obtained. Depth information of a most region in the depth histogram may be regarded as a rough scenario region. In G( d̅,σ) modeled with respect to the probability value of the scenario region using the Gaussian model based on depths of the rough scenario region, a mean d̅ and a variance σ of the depths may be calculated. A confidence of a corresponding pixel in the scenario region confidence image D may be calculated by substituting G( d̅,σ) with a depth of each pixel. That is, D(x,y)=G( d̅,σ).

Here, D(x, y) indicates a probability value that a pixel having coordinates (x, y) in the scenario region confidence image corresponds to the scenario region. d̅ and σ denote the mean and the variance of depths of the scenario region in the depth image. The scenario region confidence image D may be calculated using the Gaussian model constructed through the online training method, which is shown in FIG. 5.

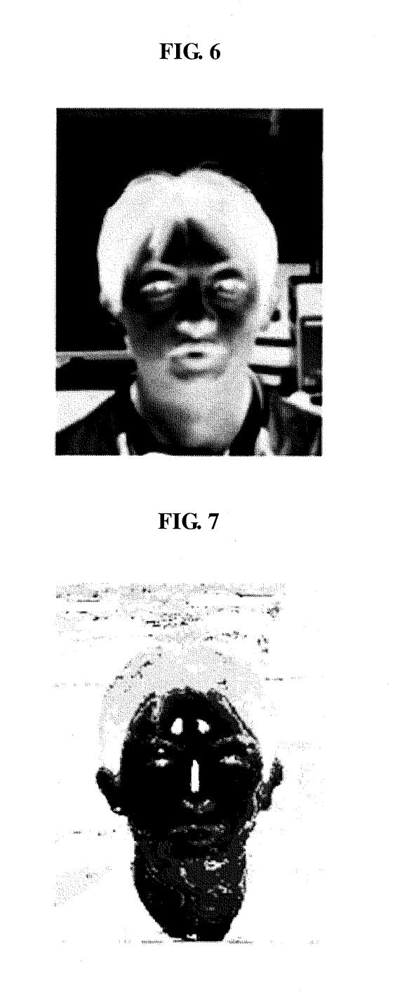

In operation 140, in the aforementioned color analysis process, the hair color confidence image H of FIG. 6 may be acquired through a method of constructing a Gaussian mixture model (GMM) for a hair color. As necessary, the non-skin color confidence image N of FIG. 7 may be acquired through the method of constructing the GMM. The hair color confidence image H indicates a probability value that each pixel in the image H is a hair color, and the non-skin color confidence image N indicates a probability value that each pixel in the image N is not a skin color.

Hereinafter, an example of aa training method of a hair color GMM will be described. Each pixel of a hair region indicated by acquiring a plurality of face images of a human being and by artificially marking the hair region may be used as a sample, and an RGB value may be converted to a hue, saturation, value (HSV) value. Next, a parameter of the GMM may be calculated using HS. Hereinafter, a training method of a skin color GMM will be described. Each pixel of a skin region indicated by acquiring a plurality of face images of a human being and by artificially marking the skin region in a face of the human being may be used as a sample, and an RGB value may be converted to an HSV value. Next, a parameter of the GMM may be calculated using HS. Hereinafter, a training method of a non-skin color GMM will be described. After training the skin color GMM, the non-skin color GMM may be obtained using 1.0-skin color GMM.

A general equation of the GMM may be expressed by

$$G ( x ) = {\sum }_{i = 1}^{M} {w}_{i} * {g}_{i} ( {μ}_{i} , {σ}_{i} , x )$$

Here, M denotes a number of single Gaussian models included in the GMM, gᵢ(μᵢ,σᵢ,x) denotes one single Gaussian model, μᵢ denotes a mean, σᵢ denotes a variance, x denotes a tonal value, and wᵢ denotes a weight of gᵢ(μᵢ,σᵢ,x).

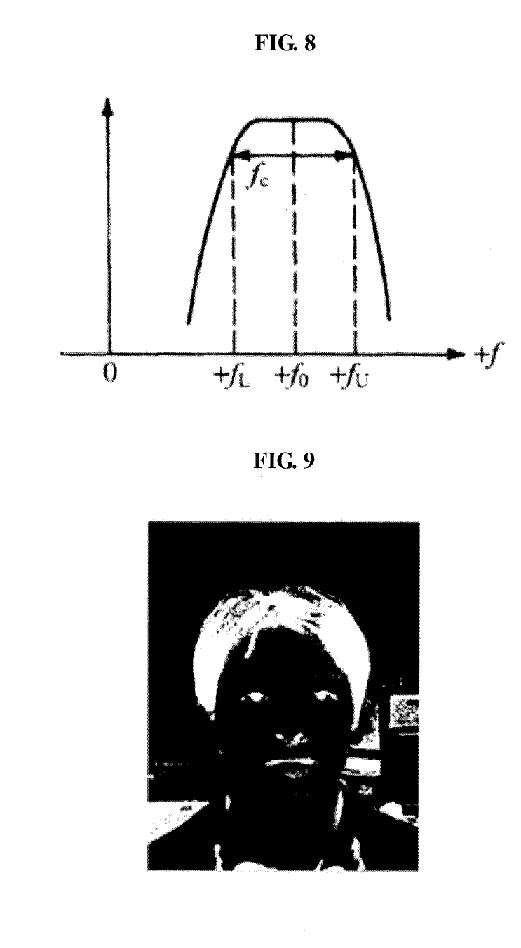

Operation 150 corresponds to a frequency analysis operation. In a frequency space, the hair region may have a very stable characteristic. As shown in FIG. 8, the hair frequency confidence image F1 may be calculated by designing a band pass filter. An upper threshold value f_{L} and a lower threshold value f_{U} of the band bass filter may be obtained through offline training, which will be described as below. After collecting hair region images and artificially segmenting the hair region, a frequency domain image of the hair region may be calculated. Statistics of H(f) that is the histogram of the hair region in the frequency domain image may be obtained so that f_{L} and f_{U} may satisfy a relationship of

$${f}_{L} = {argmin}_{f} ( H ( f ) > 0.05 ) and {f}_{U} = {argmax}_{f} ( H ( f ) < 0.95 ) .$$

Here, two equations indicate that only 5% of the value is less than f_{L} and only 5% of the value is greater than f_{U}. During the frequency analysis process, a Gaussian model of a hair frequency domain value with respect to pixels in the hair region may be constructed and the Gaussian model may be obtained through offline training. A frequency domain value may be calculated with respect to each pixel, and a probability value may be calculated by substituting the Gaussian model with the frequency domain value. Each pixel value in the frequency confidence image F1 indicates a probability value that a corresponding pixel is a hair frequency. The hair frequency confidence image F1 of FIG. 9 may be acquired.

Operation 160 corresponds to a refinement operation. In operation 160, a pixel belonging to the hair region and a pixel not belonging to the hair region may be accurately determined. Here, the following determination methods may be used.

(1) Threshold Value Method:

The threshold value method may set a different threshold value for each confidence image, and classify pixels into hair pixels and non-hair pixels. For example, when a probability value of a pixel present in a confidence image is greater than a threshold value set for the confidence image, the pixel may be determined as the hair pixel and a pixel value of the pixel may be indicated as ‘1’. Otherwise, the pixel may be determined as the non-hair pixel and a pixel value of the pixel may be indicated as ‘0’. Next, a binarization with respect to each confidence image may be performed, and an AND operation may be performed with respect to a corresponding pixel in each confidence image. A region of which pixel values calculated through the AND operation are ‘1’ may be determined as a hair region.

(2) Score Combination Method:

The score combination method may calculate a weighted sum image of each confidence image acquired from the aforementioned operations, which is different from the threshold value method. Specifically, a different confidence image may have a different weight, and a corresponding weight may be multiplied by a confidence value of a pixel (i, j) of a corresponding confidence image and then, results of multiplications may be added up. A probability value that the pixel (i, j) of the sum image is a hair pixel may be calculated. The weight may express a stability and a performance in a segmented hair region. For example, when four confidence images D, H, N, and F1 are acquired, the probability value that the pixel (i, j) is the hair pixel may be calculated according to the following equation.

s(i,j)=Wn×n(i,j)+Wf×f(i,j)+Wh×h(i,j)+Wd×d(i,j)

Here, Wn, Wf, Wh, and Wd denote weights of the confidence images D, H, N, and F1, respectively. n(i, j), f(i, j), h(i, j), and d(i, j) denote the respective corresponding probability value that the pixel (i, j) is the hair pixel in the confidence images N, F1, H, and D. s(i, j) denotes the probability value that the pixel (i, j) is the hair pixel in the sum image of the confidence images N, F1, H, and D. When the probability value s(i, j) is calculated, s(i, j) may be compared with a predetermined threshold value. When (s, j) is greater than the predetermined threshold value, the pixel (i, j) is determined to belong to the hair region and otherwise, the pixel (i, j) is determined to not belong to the hair region.

(3) Universal Binary Classifier Method:

In the universal binary classifier method, a pixel (i, j) may have an m(2≦m≦4) dimensional characteristic. Here, m may be the same as a number of acquired confidence images and the characteristic of a pixel positioned at (i, j) may vary based on classes and the number of acquired confidence images. For example, when m is ‘4’, the pixel (i, j) may have the characteristic of [d(i, j), n(i, j), h(i, j), f(i, j)]. Here, d(i, j), n(i, j), h(i, j), and f(i, j) denote the respective corresponding probability value that the pixel (i, j) is the hair pixel in the acquired confidence images D, N, H, and F1, respectively. When the acquired confidence images are N, H, and F1, the pixel (i, j) may have a characteristic of [n(i, j), h(i, j), f(i, j)]. When the acquired confidence images are D, H, and F1, the pixel (i, j) may have a characteristic of [d(i, j), h(i, j), f(i, j)]. A universal binary classifier of a linear discriminative analysis (LDA) and a support vector method (SVM) may be directly applied to determine whether the pixel (i, j) is the hair pixel.

(4) Global Optimization Method:

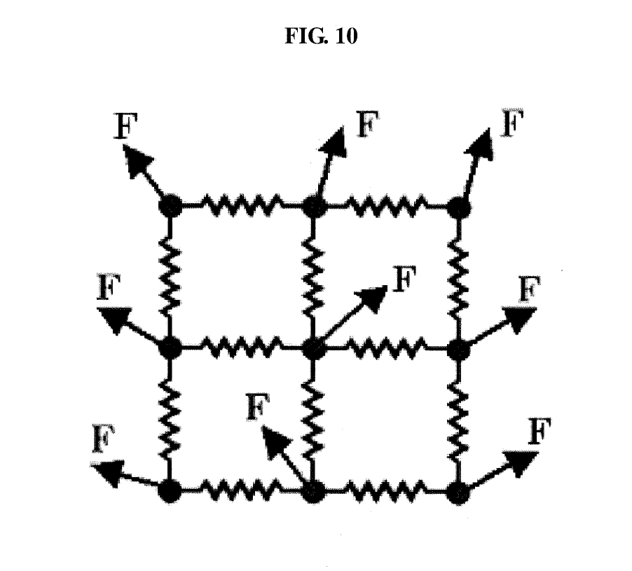

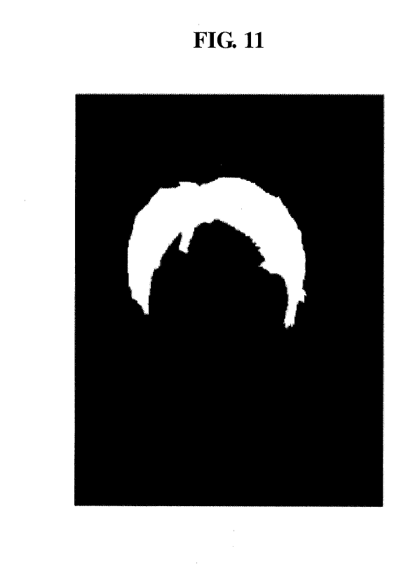

All of the aforementioned three methods are based on local information. However, when using only the local information, it may be difficult to determine whether a pixel belongs to a hair region. The global optimization method may perform a global optimization through an integral adjustment with respect to total images. For example, a graph cut, a Markov random field, and a belief propagation are currently most widely used as the global optimization method. According to example embodiments, a graph cut method may be employed as shown in FIG. 10. In FIG. 10, each vertex denotes each pixel in an image, and F denotes an external force used to pull the vertex from to a class of a corresponding pixel. In FIG. 11, when neighboring vertices are approximately connected using a spring. Here, when neighboring pixels belong to the same class, a spring may be in a relaxed state and no energy may be added. Otherwise, the spring may be in a pulled state and an amount of energy (such as one energy) may be added therebetween.

Through the global optimization method, the global energy function E(ƒ) may be constructed as below.

E(ƒ)=E_{data}(ƒ)+Eₛₘₒₒₜₕ(ƒ)

where ƒ denotes all the pixel classes, each pixel class is classified as a non-hair pixel class and a hair pixel class, E_{data}(ƒ) denotes energy generated by an external force pulling a pixel to from a class of the pixel, and Eₛₘₒₒₜₕ(ƒ) denotes a smoothness energy value of a smoothness between neighboring pixels. Even though only a single confidence image is used, the hair region may be accurately segmented using the global optimization method.

When m(2≦m≦4) confidence images are acquired, each pixel in an image may include m confidence values corresponding to a corresponding pixel in each acquired confidence image. More particularly, in the case of a pixel belonging to a hair class, data energy of the pixel may be a weighted sum of m data energies corresponding to m confidence values of the pixel. In the case of a pixel not belonging to the hair class, the data energy may be a weighted sum of m-m energies.

As a pixel value in a confidence image increases, that is, as a probability value of a pixel increases, energy for this pixel to belong to the hair region may decrease. As shown in FIG. 11, an image may be segmented into a hair region and a non-hair region using an optimization energy function.

According to example embodiments, a hair region may be accurately and quickly detected. A head region may be segmented from a single large image through a head region segmentation operation. A scenario region confidence image may be acquired through a scenario analysis operation. A non-skin color confidence image and a hair color confidence image may be acquired through a color analysis operation. A hair frequency confidence image may be acquired through a frequency analysis operation. In a refinement operation, the hair region may be more accurately and quickly segmented using the confidence image.

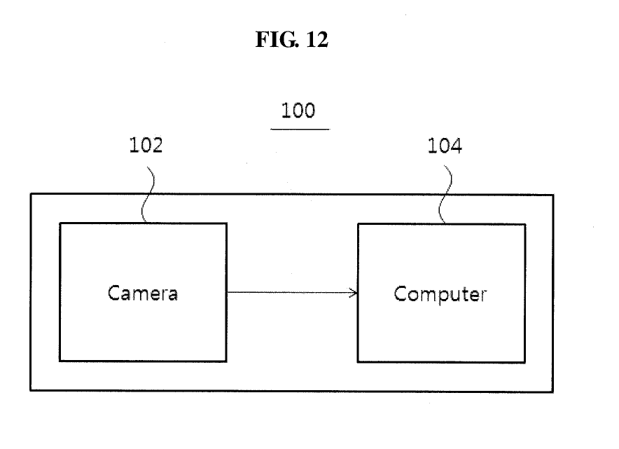

FIG. 12 illustrates an example of an apparatus 100 implementing the method of FIG. 1. As shown in FIG. 12, a camera 102 (such as discussed herein above) acquires an image of a head region, such as a color image, and transmits the color image to computer 104. Computer 104 then implements the method of FIG. 1.

The hair region detection method according to the above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

Although embodiments have been shown and described, it would be appreciated by those skilled in the art that changes may be made in these embodiments without departing from the principles and spirit of the disclosure, the scope of which is defined by the claims and their equivalents.

What is claimed is:

1. A method of detecting a hair region, comprising:
acquiring a confidence image of a head region, comprising acquiring a hair color confidence image through a color analysis with respect to the head region of a color image; and
detecting a hair region by processing the acquired confidence image.

2. The method of claim 1, wherein the acquiring of the confidence image further comprises acquiring a hair frequency confidence image through a frequency analysis with respect to a gray scale image corresponding to the head region of the color image.

3. The method of claim 2, wherein the acquiring of the confidence image further comprises calculating a scenario region confidence image through a scenario analysis with respect to a depth image corresponding to the head region of the color image.

4. The method of claim 3, wherein the acquiring of the confidence image comprises acquiring a non-skin color confidence image through the color analysis with respect to the head region of the color image.

5. The method of claim 4, wherein the detecting comprises setting, to ‘1’, a pixel having a pixel value greater than a corresponding threshold value in each confidence image, based on a threshold value predetermined for each confidence image, and setting, to ‘0’, a pixel having a pixel value less than or equal to the corresponding threshold value, performing an AND operation with respect to a corresponding pixel of each confidence image, and determining, as the hair region, a region having a pixel value of ‘1’.

6. The method of claim 4, wherein the processing comprises calculating a pixel value of a corresponding pixel of a sum-image of each confidence image by multiplying a pixel value of each confidence image by a weight predetermined for each confidence image, and by adding up results of the multiplication, and determining whether the corresponding pixel of the sum-image belongs to the hair region based on a predetermined threshold value.

7. The method of claim 4, wherein the processing comprises determining whether a pixel belongs to the hair region, using a universal binary classifier based on each confidence image.

8. The method of claim 4, wherein the processing comprises determining whether a corresponding pixel belongs to the hair region using a global optimization method with respect to the acquired confidence image.

9. The method of claim 8, wherein the global optimization method corresponds to a graph cut method, and the graph cut method minimizes an energy function E(ƒ) and segments an image into the hair region and a non-hair region, and the energy function is given by,
E(ƒ)=E_{data}(ƒ)+Eₛₘₒₒₜₕ(ƒ),
where ƒ denotes all the pixel classes, each pixel class is classified as a non-hair pixel class and a hair pixel class, E_{data}(ƒ) denotes energy generated by an external force pulling a pixel to from a class of the pixel, and Eₛₘₒₒₜₕ(ƒ) denotes a smoothness energy value of a smoothness between neighboring pixels.

10. The method of claim 9, wherein:
when m confidence images are present, each pixel value of an image has m confidence values corresponding to the m confidence images, and
when a pixel is indicated by a hair class, data energy of the pixel corresponds to a weighted sum of m energies corresponding to m confidence values, and otherwise, the data energy of the pixel corresponds to a weighted sum of m-m energies where 2≦m≦4.

11. The method of claim 1, further comprising:
obtaining a head region of the color image through segmentation of the color image.

12. The method of claim 11, wherein a head region of a depth image corresponding to the color image is determined based on a size and a position of the head region of the color image.

13. At least one non-transitory computer-readable medium storing computer-readable instructions to control at least one processor to implement the method of claim 1.

14. An apparatus comprising:
a camera acquiring a color image of a head region; and
at least one processor, coupled to the camera, acquiring a confidence image of the head region, comprising acquiring a hair color confidence image through a color analysis with respect to the head region of the color image, and detecting a hair region by processing the acquired confidence image
